(19) United States
(12) Patent Application Publication
(10) Pub. No.: US 2020/0281809 A1
(43) Pub. Date: Sep. 10, 2020

(54) Rechargeable Dual Massage Apparatus

(71) Applicant: HOMELEC KOREA CO., LTD., Seoul (KR)

(72) Inventor: GeonWoo PARK, Changwon (KR)

(21) Appl. No.: 16/881,976

(22) Filed: May 22, 2020

Related U.S. Application Data
(63) Continuation of application No. 15/110,695, filed on Sep. 28, 2016.

(30) Foreign Application Priority Data
Jan. 8, 2014 (KR) 10-2014-0002382

(51) Int. Cl. A61H 23/02; A61H 7/00

(52) U.S. Cl. CPC A61H 23/02; A61H 2201/1207; A61H 2205/021; A61H 2201/1671; A61H 2205/022; A61H 2201/1664; A61H 2201/0188; A61H 2205/084; A61H 2205/06; A61H 2201/5038; A61H 2205/081; A61H 2205/062; A61H 2201/0153; A61H 2201/0157; A61H 7/005

(57) ABSTRACT

The rechargeable dual massage apparatus may be used in a wireless state after being charged, the user may more conveniently use the rechargeable dual massage apparatus without being restricted by location and movement, and since both of the strong vibrator and the weak vibrator, which have different intensities, are installed at the front and rear sides of the handle portion so as to enable the user to selectively use the strong vibrator and the weak vibrator, the user may softly massage sensitive body parts such as the face or the scalp as well as the abdomen, the back, the arms, and the legs.

### CROSS-REFERENCE TO RELATED APPLICATIONS

The present application is a continuation of U.S. application Ser. No. 15/110,695 filed on Sep. 28, 2016, which is a national-stage under 35 USC § 371 of PCT international Application No. PCT/KR2014/002922 filed on Apr. 4, 2014, and claims priority to Korean patent application No. 10-2014-0002382 filed on Jan. 8, 2014, and the entire disclosures of the above-mentioned applications are incorporated by reference herein.

### TECHNICAL FIELD

The present invention relates to a rechargeable dual massage apparatus which may be used in a wireless state after being charged.

### BACKGROUND ART

In general, a massage apparatus is used to massage body parts by using vibration, and a portable massage apparatus is provided such that a user usually holds the portable massage apparatus by hand and moves the portable massage apparatus so as to massage a part of the body. As disclosed in Korean Utility Model Registration No. 0173225, the portable massage apparatus broadly includes a head for generating vibration, and a handle, such that the user may massage the body by holding the handle and moving the head, and an electric wire for supplying electric power is connected to a rear end of the handle.

Because the massage apparatus in the related art may be used only in a state in which a plug of the electric wire is put into an electrical outlet, there are problems in that the massage apparatus is restricted by location, and the user is inconvenienced by the electric wire when moving the massage apparatus.

In addition, a powerful motor is included in the head of the massage apparatus because the massage apparatus in the related art is usually used to massage the abdomen, the back, the arms, the legs, and the like, and as a result, it is not appropriate to massage sensitive body parts such as the face even though intensity of massage is reduced. Therefore, the user suffers from the inconvenience of preparing a separate soft massage apparatus in order to massage sensitive body parts such as the face or the scalp.

### DISCLOSURE

### Technical Problem

The present invention has been made in an effort to provide a rechargeable dual massage apparatus which may be used in a wireless state after being charged, and has a weak vibrator that has low intensity and is installed at a rear end of a handle portion where an electric wire was connected in the related art, thereby enabling a user to selectively use the weak vibrator and a strong vibrator that has high intensity and is installed at a front side of the handle portion.

### Technical Solution

A rechargeable dual massage apparatus according to the present invention includes: a housing which includes a head portion at a front side of the housing, and a handle portion at a rear side of the head portion; a soft cap which is coupled to a rear end of the handle portion, and extends and protrudes from the handle portion; a strong vibrator which is installed in the head portion of the housing, and to which a massaging member for massaging the body is detachably coupled at a lower side of the head portion; a weak vibrator which is coupled to a rear side of the handle portion of the housing, and transmits vibration to the soft cap; a charging terminal which is installed on the housing; a rechargeable battery which is installed in the housing, charged with electric power through the charging terminal, and supplies electric power to the strong vibrator and the weak vibrator; a volume switch which is installed on the housing, turns on or off a power source by being rotated, and adjusts intensity of the strong vibrator or the weak vibrator in a stepless manner after turning on the power source; and a control unit which is installed in the housing, and operates the strong vibrator or the weak vibrator in accordance with the on/off operation of the volume switch, such that the strong vibrator operates when the volume switch adjusts intensity within a predetermined time in a state in which the volume switch is turned on, and the weak vibrator operates when the volume switch adjusts intensity after a predetermined time has passed in a state in which the volume switch is turned on.

The rechargeable dual massage apparatus includes a lamp which is installed on the housing, and indicates a charging state or an operating state.

The rechargeable dual massage apparatus includes a buzzer which is installed on the housing, and informs that a predetermined time has passed in a state in which the volume switch is turned on.

The rechargeable dual massage apparatus includes an auxiliary massaging member which massages the face or the scalp in a state in which the auxiliary massaging member is fitted into the soft cap.

### Advantageous Effects

Since the rechargeable dual massage apparatus according to the present invention may be used in a wireless state after being charged, the user may more conveniently use the rechargeable dual massage apparatus without being restricted by location and movement, and since both of the strong vibrator and the weak vibrator, which have different intensities, are installed at the front and rear sides of the handle portion so as to enable the user to selectively use the strong vibrator and the weak vibrator, the user may softly massage sensitive body parts such as the face or the scalp as well as the abdomen, the back, the arms, and the legs.

### DESCRIPTION OF DRAWINGS

FIG. 1 is a perspective view illustrating a rechargeable dual massage apparatus to which the present invention is applied.

FIG. 2 is a perspective view illustrating a charging state of the rechargeable dual massage apparatus to which the present invention is applied.

FIG. 3 is a cross-sectional view illustrating a rear end of a handle of the rechargeable dual massage apparatus to which the present invention is applied.

FIG. 4 is a top plan view illustrating an operating unit of the rechargeable dual massage apparatus to which the present invention is applied.

FIG. 5 is a block diagram illustrating a configuration of the rechargeable dual massage apparatus to which the present invention is applied.

FIG. 6 is a side view illustrating an exemplary embodiment of the rechargeable dual massage apparatus to which the present invention is applied.

### BEST MODE

The exemplary embodiments of the present invention will be specifically described with reference to the accompanying drawings.

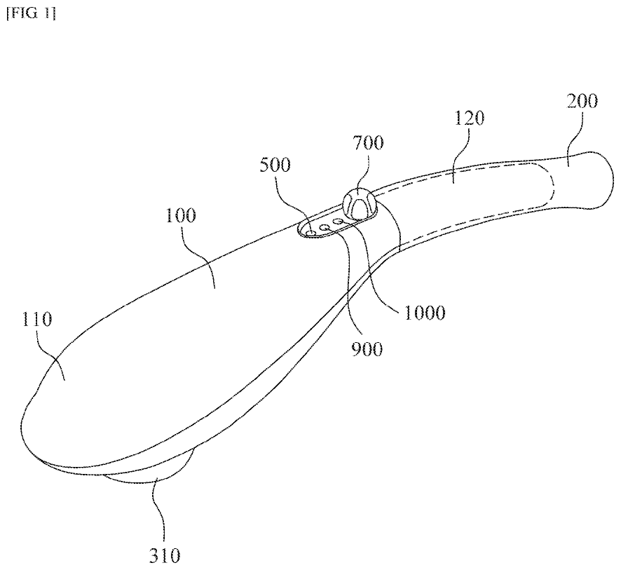

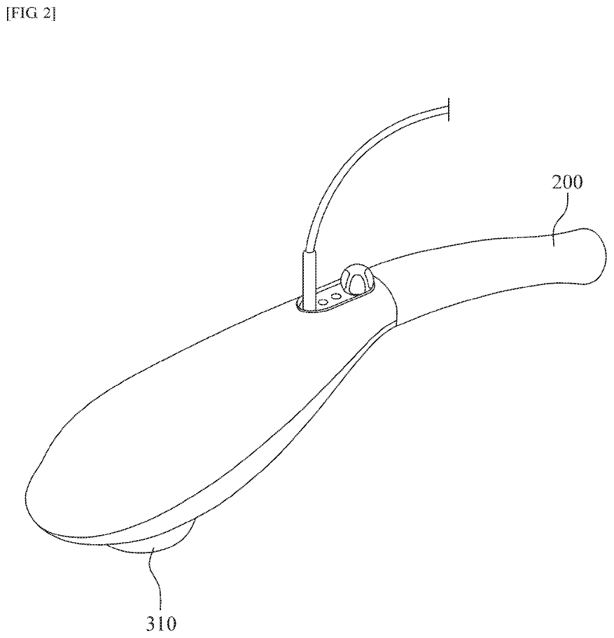

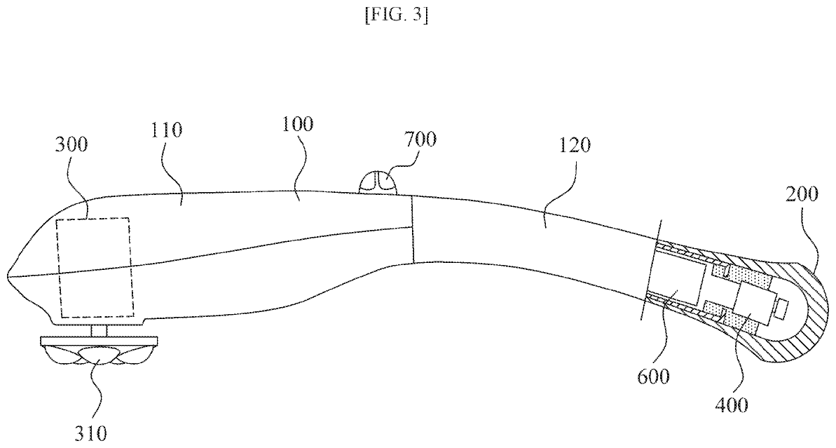

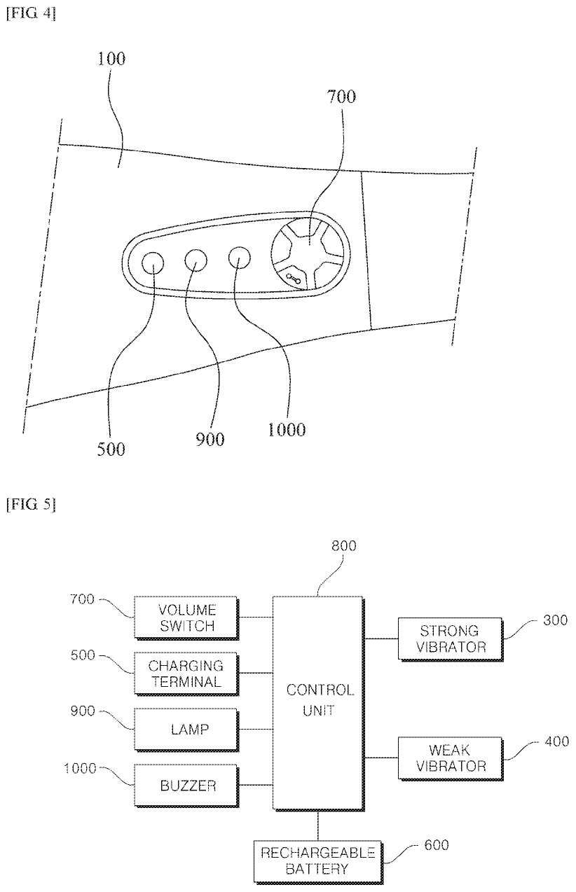

As illustrated in FIGS. 1 to 6, a rechargeable dual massage apparatus according to the present invention includes a housing 100, a soft cap 200, a strong vibrator 300, a weak vibrator 400, a charging terminal 500, a rechargeable battery 600, a volume switch 700, and a control unit 800.

The housing 100 includes a head portion 110 at a front side of the housing 100, and a handle portion 120 at a rear side of the head portion 110, and the housing 100 is made of a typical synthetic resin material having high durability.

In this case, the charging terminal 500, the volume switch 700, and a lamp 900 or a buzzer 1000, which will be described below, are installed at one side of the housing 100, and the rechargeable battery 600 and the control unit 800, together with the strong vibrator 300, are installed in the housing 100. Meanwhile, the weak vibrator 400 to be described below is installed at a rear side of the handle portion 120 of the housing 100.

The soft cap 200 is coupled to a rear end of the handle portion 120, and extends and protrudes from the handle portion 120. That is, the soft cap 200 is made of a silicone material so that a user may softly massage, for example, the face or the scalp by using vibration generated in the soft cap 200 while directly rubbing the face or the scalp with the soft cap 200.

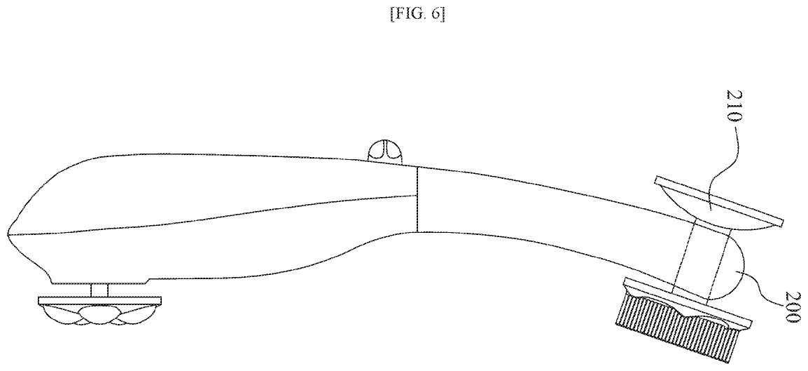

As an exemplary embodiment, as illustrated in FIG. 6, the soft cap 200 includes an auxiliary massaging member 210 for massaging the face or the scalp in a state in which the auxiliary massaging member 210 is fitted into the soft cap 200. As illustrated in the drawing, the auxiliary massaging member 210 is formed in the form of a ring so as to be fitted into the soft cap 200, and may have an acupressure protrusions formed at one side so as to massage the scalp, and a cushion formed at the other side so as to massage the face.

The strong vibrator 300 is installed in the head portion 110 of the housing 100, and a massaging member 310 for massaging the body is detachably coupled to the strong vibrator 300 at a lower side of the head portion 110. That is, like a typical massage apparatus, the strong vibrator 300 is used to massage the abdomen, the shoulder, the back, the arms, the legs, and the like, and configured to generate strong vibration suitable for the massage.

The weak vibrator 400 is coupled to the rear side of the handle portion 120 of the housing 100, the handle portion 120 of the housing 100, and configured to transmit vibration to the soft cap 200. That is, the weak vibrator 400 is used to massage sensitive parts such as the face or the scalp, and configured to generate weak vibration suitable for the massage.

The charging terminal 500 is installed on the housing 100, and configured such that a terminal pin of a charging adapter including a plug is fitted into the charging terminal 500 so that the charging terminal 500 may be supplied with electric power from a commercially available power source.

The rechargeable battery 600 is installed in the housing 100, and configured to be charged with electric power through the charging terminal 500 and to supply electric power to the strong vibrator 300 and the weak vibrator 400. A lithium-ion battery is used as the rechargeable battery 600, and thus the rechargeable battery 600 may be continuously used, for example, for over two hours after being charged for two hours.

The volume switch 700 is installed on the housing 100, and configured to turn on or off the power source by being rotated, and to adjust intensity of the strong vibrator 300 or the weak vibrator 400 in a stepless manner after turning on the power source. That is, the volume switch 700 may softly and precisely adjust intensity of the strong vibrator and the weak vibrator without impact, thereby improving convenience for use.

The control unit 800 is installed in the housing 100, and operates the strong vibrator 300 or the weak vibrator 400 in accordance with the on/off operation of the volume switch 700, such that the strong vibrator 300 operates when the volume switch 700 adjusts intensity within a predetermined time in a state in which the volume switch 700 is turned on, and the weak vibrator 400 operates when the volume switch 700 adjusts intensity after a predetermined time has passed in a state in which the volume switch 700 is turned on. That is, the control unit 800 controls a circuit so as to adjust both of the strong vibrator 300 and the weak vibrator 400 by using the single volume switch 700, and for example, in order to use the strong vibrator 300, the user rotates the volume switch to increase intensity before one minute passes after the user rotates the volume switch to turn on the volume switch 700, and in order to use the weak vibrator 400, the user rotates the volume switch to adjust intensity after one minute has passed after the user rotates the volume switch to turn on the volume switch 700. In order to use the strong vibrator 300 after using the weak vibrator 400, the user turns off the volume switch 700, and then uses the strong vibrator 300 again.

In this configuration, the lamp 900 is installed on the housing 100 in order to indicate a charging state or an operating state of the rechargeable battery 600. For example, the lamp 900 emits red light while the adapter is plugged into the charging terminal 500 and the rechargeable battery 600 is charged, and the lamp 900 emits green light when the rechargeable battery 600 is completely charged. In addition, the lamp 900 is turned off in a state in which the volume switch 700 is turned off, and the lamp 900 may emit yellow light in a state in which the volume switch 700 is turned on.

In addition, the buzzer 1000 may be installed on the housing 100 so as to inform that a predetermined time has passed in a state in which the volume switch 700 is turned on. That is, the buzzer 1000 serves to inform the user of a point in time when the operation is changed to the weak vibrator 400.

According to the configuration of the present invention, since the rechargeable dual massage apparatus may be used in a wireless state after being charged, the user may more conveniently use the rechargeable dual massage apparatus without being restricted by location and movement, and since both of the strong vibrator and the weak vibrator, which have different intensities, are installed at the front and rear sides of the handle portion so as to enable the user to selectively use the strong vibrator and the weak vibrator, the user may softly massage sensitive body parts such as the face or the scalp as well as the abdomen, the back, the arms, and the legs.

While the present invention has been described by the limited exemplary embodiments as described above, the technical spirit of the present invention is defined by the claims.

1. A rechargeable massage apparatus comprising:
a housing which includes a head portion at a front side of the housing, and a handle portion at a rear side of the head portion;
a soft cap which is coupled to a rear end of the handle portion, and extends and protrudes from the handle portion;
a strong vibrator which is installed in the head portion of the housing, and to which a massaging member for massaging the body is detachably coupled at a lower side of the head portion;
a weak vibrator which is coupled to a rear side of the handle portion of the housing, and transmits vibration to the soft cap;
a charging terminal which is installed on the housing;
a rechargeable battery which is installed in the housing, charged with electric power through the charging terminal, and supplies electric power to the strong vibrator and the weak vibrator;
a volume switch which is installed on the housing, turns on or off a power source by being rotated, and adjusts intensity of the strong vibrator or the weak vibrator in a stepless manner after turning on the power source; and
a control unit which is installed in the housing, and operates the strong vibrator or the weak vibrator in accordance with the on/off operation of the volume switch, such that the strong vibrator operates when the volume switch adjusts intensity within a predetermined time in a state in which the volume switch is turned on, the strong vibrator operates when the volume switch adjusts intensity within a predetermined time in a state in which the volume switch is turned on, and the weak vibrator operates when the volume switch adjusts intensity after a predetermined time has passed in a state in which the volume switch is turned on.

2. The rechargeable massage apparatus of claim 1, comprising:
a lamp which is installed on the housing, and indicates a charging state or an operating state.

3. The rechargeable massage apparatus of claim 1, comprising:
a buzzer which is installed on the housing, and informs that a predetermined time has passed in a state in which the volume switch is turned on.

4. The rechargeable massage apparatus of claim 1, comprising:
an auxiliary massaging member which massages the face or the scalp in a state in which the auxiliary massaging member is fitted into the soft cap.
